(19) United States
(12) Patent Application Publication
(10) Pub. No.: US 2011/0157527 A1
(43) Pub. Date: Jun. 30, 2011

(54) LIQUID CRYSTAL DISPLAY DEVICE

(76) Inventors: Young-Jik JO, Paju-si (KR); Hyun-Cheol JIN, Paju-si (KR); Tae-Gyun KIM, Paju-si (KR); Sang-Wook LEE, Paju-si (KR); Chang-Seung WOO, Seongnam-si (KR); Da-Hye SHIM, Paju-si (KR)

(21) Appl. No.: 12/946,511

(22) Filed: Nov. 15, 2010

(30) Foreign Application Priority Data
Dec. 29, 2009 (KR) 10-2009-0132983

(51) Int. Cl. G02F 1/1335; G02F 1/1333

(52) U.S. Cl. 349/106; 349/110; 349/111

(57) ABSTRACT

A liquid crystal display device capable of preventing light leakage and vertical crosstalk thereof is disclosed. The liquid crystal display device includes a first substrate in which a pixel region and a data line region next to the pixel region are defined, a data line formed on the data line region of the first substrate with a first insulating film interposed therebetween, two outermost common electrodes of the adjacent two pixels spaced apart from opposite edges of the data line, a shield layer having two segments, each segment has one side of which overlaps an edge of the data line by a width of 0 μm or more to 2 μm or less and the other side of which overlaps an edge of one of the two outermost common electrodes with the first insulating film interposed therebetween, and a second substrate bonded opposite to the first substrate.

This application claims the benefit of Korean Patent Application No. 10-2009-0132983, filed on Dec. 29, 2009, which is hereby incorporated by reference as if fully set forth herein.

### BACKGROUND OF THE INVENTION

1. Field of the Invention

The present invention relates to a liquid crystal display device, and more particularly, to a liquid crystal display device capable of preventing light leakage and vertical crosstalk thereof.

2. Discussion of the Related Art

As demands for display devices are increasing with expansion in information technology, flat panel display devices, such as Liquid Crystal Display (LCD) devices, Plasma Display Panel (PDP) devices, Electro Luminescent Display (ELD) devices, Field Emission Display (FED) devices, Vacuum Fluorescent Display (VFD) devices, and so on, have been actively studied. Of these flat panel display devices, LCD devices are a focus of attention owing to advantages of high definition, mass-productivity, easy driving mechanism, light weight, slim design, low power consumption, and so on.

A liquid crystal display device is designed to display a desired image in such a manner that data signals depending on image information are individually applied to pixels arranged in a matrix form to adjust transmittance on a per pixel basis. Such a liquid crystal display device is mainly driven in an Active Matrix (AM) manner. An AM driving manner is a kind of liquid crystal driving method, in which switching elements, such as Thin Film Transistors (TFTs), are added to pixels respectively such that voltage is applied to liquid crystals of the pixels via the TFTs to drive the liquid crystals.

Generally, the liquid crystal display device includes a liquid crystal panel in which liquid crystal cells are arranged in a matrix form, and a driving circuit to drive the liquid crystal panel. The liquid crystal panel includes a thin film transistor substrate provided with thin film transistors, a color filter substrate provided with color filter layers, and a liquid crystal layer formed between the thin film transistor substrate and the color filter substrate.

A plurality of pixel regions is defined in the thin film transistor substrate by gate lines and data lines crossing each other. Also, pixel electrodes and common electrodes are formed on the thin film transistor substrate, to create an electric field for driving the liquid crystal layer. The color filter layers of the color filter substrate are provided to correspond to the pixel regions, and a black matrix is formed between the color filter layers to correspond to the gate lines, the data lines and the thin film transistors.

The black matrix serves to prevent light, emitted from a backlight unit provided underneath the thin film transistor substrate, from leaking from opposite sides of the data lines. However, if the thin film transistor substrate and the color filter substrate are erroneously bonded to each other, it may often cause a light leakage defect because the black matrix fails to completely cover light leakage regions. Although increasing the width of the black matrix has been proposed to solve the above described problem, this may remarkably deteriorate the opening ratio of the liquid crystal display device.

To solve deterioration in the opening ratio, a method for providing a metal float line, which has a greater width than the data line, below the data line has been proposed. However, with this configuration, if a positive potential is applied to one pixel electrode and a negative potential is applied to an opposite pixel electrode on the basis of the data line as illustrated in FIG. 1, a first potential difference A occurs between the float line and one pixel region.

In this case, since parasitic capacitance is proportional to the width of an overlap region between the data line and the metal float line, increasing the overlap region may increase the first potential difference A and consequently, may increase a second potential difference B that causes an abnormal electric field at the pixel electrode. Accordingly, the increased second potential difference B may generate vertical crosstalk, resulting in deterioration in the reliability of the liquid crystal display device.

### SUMMARY OF THE INVENTION

Accordingly, the present invention is directed to a liquid crystal display device that substantially obviates one or more problems due to limitations and disadvantages of the related art.

An object of the present invention is to provide a liquid crystal display device capable of preventing light leakage and vertical crosstalk thereof.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a liquid crystal display device includes a first substrate in which a pixel region and a data line region next to the pixel region are defined, a data line formed on the data line region of the first substrate with a first insulating film interposed therebetween, two outermost common electrodes of the adjacent two pixels spaced apart from opposite edges of the data line, a shield layer having two segments, each segment has one side of which overlaps an edge of the data line by a width of 0 μm or more to 2 μm or less and the other side of which overlaps an edge of one of the two outermost common electrodes with the first insulating film interposed therebetween, and a second substrate bonded opposite to the first substrate.

The shield layer may be configured such that the two segments are spaced apart from each other with the data line interposed therebetween.

The shield layer may be formed on the same layer as a gate line and may be spaced apart form the gate line, the gate line crossing the data line to define the pixel region.

The shield layer may be made of an opaque conductive material.

The shield layer may overlap the edge of the data line with the first insulating film interposed therebetween, and may overlap the edge one of the two outermost common electrodes with the first insulating film and a second insulating film on the data line interposed therebetween.

The shield layer may be formed in the same direction as the data line, and the two segments of the shield layer may be spaced apart from the center of the data line.

The shield layer may be made of the same material as a gate line and may be spaced apart from the gate line, the gate line crossing the data line to define the pixel region.

The shield layer may be formed between the data line and the outermost common electrode.

A black matrix may be formed on the second substrate to correspond to the data line region, and a color filter layer may be formed on the second substrate to correspond to the pixel region.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating a problem of the prior art;

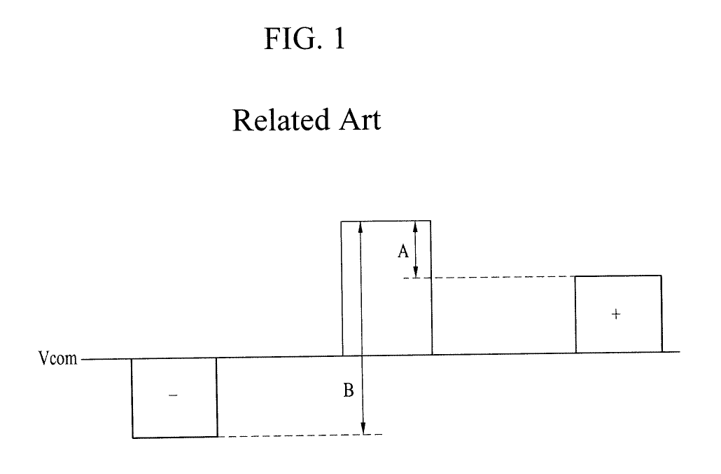

FIG. 2 is a plan view illustrating a sub pixel of a liquid crystal display device according to an embodiment of the present invention;

FIG. 3A is a sectional view taken along the line I-I′ of FIG. 2; and

FIG. 3B is a view illustrating the effect of the configuration illustrated in FIG. 3A.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Hereinafter, a liquid crystal display device according to the present invention will be described in detail with reference to the accompanying drawings.

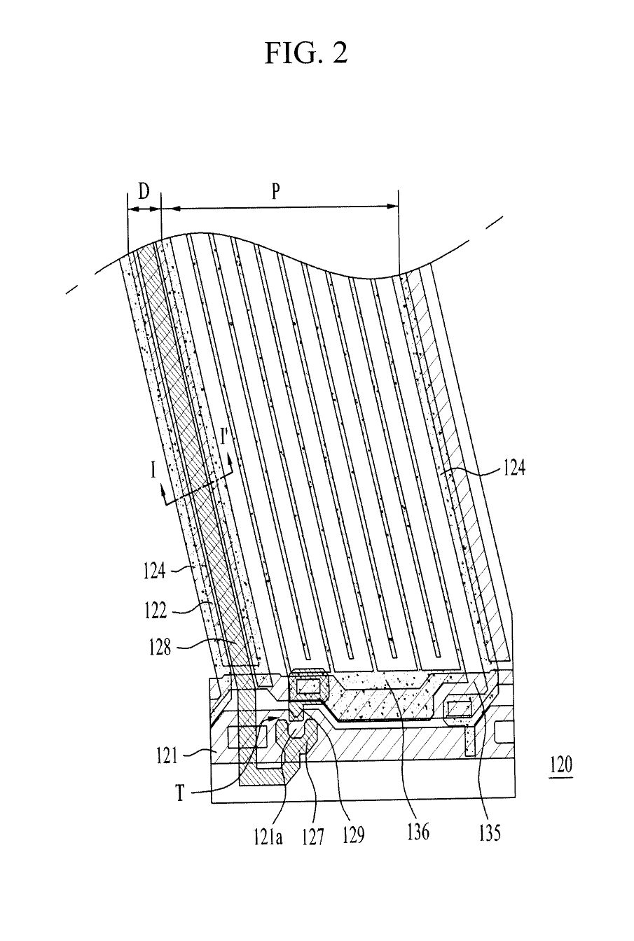

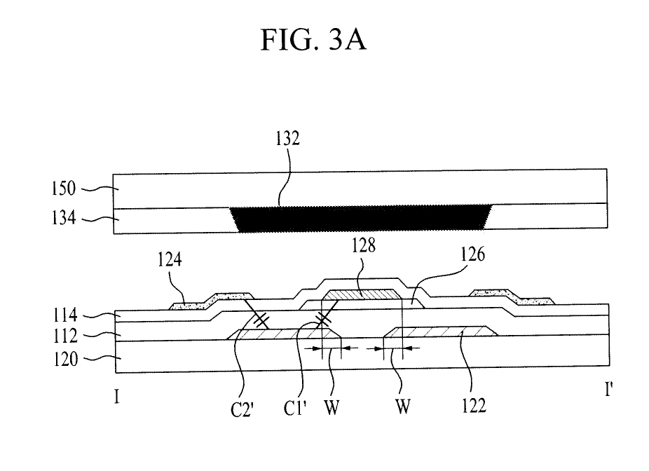

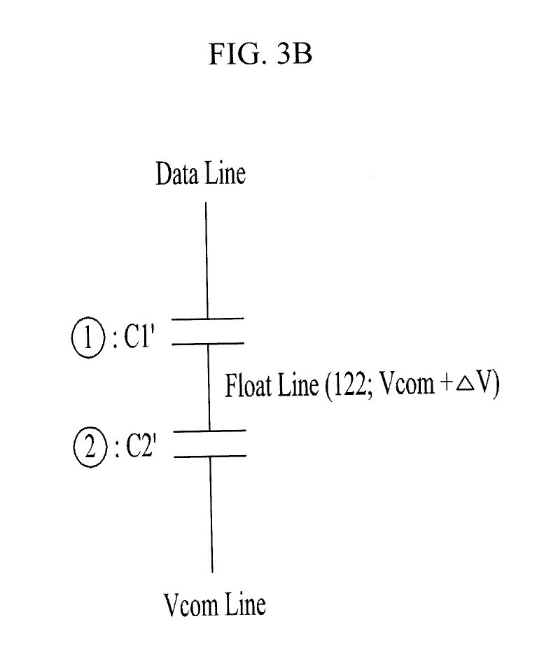

FIG. 2 is a plan view illustrating a sub pixel of the liquid crystal display device according to an embodiment of the present invention, and FIG. 3A is a sectional view taken along the line I-I′ of FIG. 2.

The liquid crystal display device according to the present invention includes a first substrate 120, a second substrate 150, and a liquid crystal layer (not shown) between the first substrate 120 and the second substrate 150. The first substrate 120 is a thin film transistor substrate in which a pixel region P and a data line region D are defined, and the second substrate 150 is a color filter substrate bonded opposite to the first substrate 120.

Although the liquid crystal display device includes M×N sub pixels defined by N gate lines 121 and M data lines 128 crossing each other, for the sake of simplified description, a single sub pixel is illustrated in the drawing.

The pixel region P is defined on the transparent first substrate 120 by the gate lines 121 extending in a first direction and the data lines 128 crossing the gate lines 121. A thin film transistor T is arranged at an intersection of the gate line 121 and the data line 128 and serves to switch on or off each pixel.

The thin film transistor T includes a gate electrode 121a formed of a part of the gate line 121, a semiconductor layer 126 formed on the gate electrode 121a, a source electrode 127 extending from the data line 128 and formed on the semiconductor layer 126, and a drain electrode 129. In this case, a scan signal and a data signal applied from an external driving circuit (not shown) are applied respectively to the gate line 121 and the data line 128.

The pixel region P contains common electrodes 124 and pixel electrodes 136 formed on the first substrate 120, which take the form of strips successively repeated and spaced apart from one another. The common electrodes 124 are electrically connected to a common line 135, and the pixel electrodes 136 are electrically connected to the drain electrode 129 of the thin film transistor T. The common electrodes 124 and the pixel electrodes 136 are made of a transparent conductive material, such as Indium Tin Oxide (ITO) or Indium Zinc Oxide (IZO).

The second substrate 150 is provided with a color filter layer 134 to correspond to the pixel region P. The color filter layer 134 includes Red, Green and Blue color filter layers formed on a per sub pixel basis, but is not limited thereto.

The data line region D is a region where the data line 128 located next to a Y-axis edge of the pixel region P is formed. A shield layer 122 having two segments, a first insulating film 112, the data line 128 and two outermost common electrodes of the common electrodes 124 of the adjacent two pixels may be formed on the data line region D of the first substrate 120. In addition, the data line region D of the first substrate 120 may contain the semiconductor layer 126 between the insulating film 112 and the data line 128, and a second insulating film 114 formed on the data line 128.

The shield layer 122 serves to prevent light emitted from the backlight unit (not shown) provided underneath the first substrate 120 from leaking from opposite sides of the data line 128. The shield layer 122 is made of the same opaque conductive material as the gate electrode 121a or the gate line 121, and is formed on the same layer as the gate electrode 121a or the gate line 121 so as to be floated, i.e. spaced apart from the gate electrode 121a and the gate line 121.

The shield layer 122 is formed underneath the first insulating film 112 between the data line 128 and the two outermost common electrodes 124 of the adjacent two pixels P, each outermost common electrodes 124 is located at the edge of the pixel region P to extend in the same direction as the data line 128. In this case, the shield layer 122 may be configured such that the two segments of the shield layer 122 are spaced apart from each other with the data line 128 interposed therebetween so as to partially overlap opposite edges of the data line 128. No shield layer 122 is present immediately below the center of the data line 128.

The width W of an overlap region between the shield layer 122 and the data line 128 may be 0 μm or more to 2 μm or less. Specifically, one side of each segment of the shield layer 122 overlaps an edge of the data line 128 by a width of 2 μm or less with the first insulating film 112 interposed therebetween, and the other side of each segment of the shield layer 122 overlaps an edge of the outermost common electrode 124 with the first insulating film 112 and the second insulating film 114 interposed therebetween.

More preferably, the width W of the overlap region between the shield layer 122 and the data line 128 may be greater than 0 μm and equal to or less than 2 μm. If the width W of the overlap region between the shield layer 122 and the data line 128 is 0 μm or less, i.e. the shield layer 122 and the data line 128 do not overlap each other, it may be necessary to form a black matrix 132 to prevent light leakage through a gap between the shield layer 122 and the data line 128. This results in deterioration in the opening ratio of the liquid crystal display device.

However, in the present invention, as the shield layer 122 is formed between the data line 128 and the outermost common electrode 124 such that opposite edges of each segment of the shield layer 122 overlap the edges of the data line 128 and the outermost common electrode 124, it may be possible to completely prevent light emitted from a backlight unit (not shown) from leaking from opposite sides of the data line 128.

This enables elimination of the black matrix 132 that has been conventionally used to prevent light leakage. As a result, the opening area of the pixel region P increases, resulting in enhancement in the opening ratio of the liquid crystal display device.

The opaque conductive material constituting the shield layer 122 may be a low resistance opaque conductive material, such as aluminum (Al), aluminum alloy, tungsten (W), copper (Cu), chromium (Cr), molybdenum (Mo), and so on. In addition, a multilayer structure in which two or more low resistance opaque conductive materials are stacked one atop another may be used.

Assuming that the shield layer 122 is made of the same opaque conductive material as the gate electrode 121a or the gate line 121, a first parasitic capacitance C1′ is generated between the data line 128 and the shield layer 122 and a second parasitic capacitance C2′ is generated between the shield layer 122 and the outermost common electrode 124.

In this case, voltage applied to the shield layer 122, as illustrated in FIG. 3B, varies under the influence of a voltage variation of the data line 128. A voltage variation ΔV′ of the shield layer 122 may be represented by the following Equation 1.

$$Δ {V}^{′} = \frac{C {1}^{′}}{C {1}^{′} + C {2}^{′}} ( V 2 - V 1 ) \qquad Equation 1$$

In the above Equation 1, “V2” and “V1” represent voltage applied to the data line 128. If the voltage variation ΔV′ of the shield layer 122 is great, vertical crosstalk may occur easily. Therefore, it is necessary to reduce the voltage variation ΔV′ of the shield layer 122. Since a difference between the voltage V2 and the voltage V1 applied to the data line 128 is constant, it will be appreciated that the voltage variation ΔV′ of the shield layer 122 is proportional to the first parasitic capacitance C1′.

The shield layer 122 of the present invention is configured such that two segments of the shield layer 122 are spaced apart from each other with the data line 128 interposed therebetween and the width W of the overlap region between the data line 128 and the shield layer 122 is 0 μm or more to 2 μm or less. More preferably, the width W of the overlap region between the data line 128 and the shield layer 122 is greater than 0 μm and equal to or less than 2 μm.

Accordingly, the present invention may reduce the first parasitic capacitance C1′ by increasing a distance between the data line 128 and the shield layer 122 and reducing the width W of the overlap region between the data line 128 and the shield layer 122. That is, the present invention may reduce the voltage variation ΔV′ of the shield layer 122 by reducing the first parasitic capacitance C1′, thereby preventing light leakage and vertical crosstalk while achieving a desired opening ratio of the liquid crystal display device.

In the meantime, the black matrix 132 may be formed on the second substrate 150 to correspond to the data line region D, to prevent light leakage from opposite sides of the data line 128 formed on the first substrate 120.

As is apparent from the above description, in a liquid crystal display device according to the present invention, an overlap region between a shield layer and a data line is minimized. This has the effects of preventing light leakage while achieving a desired opening ratio, resulting in enhancement in image quality.

Further, when reducing the overlap region between the conductive shield layer and the data line and increasing a distance between the shield layer and the data line, parasitic capacitance between the shield layer and the data line may be reduced. This has the effect of preventing vertical crosstalk.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A liquid crystal display device comprising:
a first substrate in which a pixel region and a data line region next to the pixel region are defined;
a data line formed on the data line region of the first substrate with a first insulating film interposed therebetween;
two outermost common electrodes of the adjacent two pixels spaced apart from opposite edges of the data line;
a shield layer having two segments, each segment has one side of which overlaps an edge of the data line by a width of 0 μm or more to 2 μm or less and the other side of which overlaps an edge of one of the two outermost common electrodes, with the first insulating film interposed therebetween; and
a second substrate bonded opposite to the first substrate.

2. The device according to claim 1, wherein the two segments of the shield layer are spaced apart from each other with the data line interposed therebetween.

3. The device according to claim 1, wherein the shield layer is formed on the same layer as a gate line and is spaced apart from the gate line, the gate line crossing the data line to define the pixel region.

4. The device according to claim 1, wherein the shield layer is made of an opaque conductive material.

5. The device according to claim 1, wherein each segment of the shield layer overlaps the edge of the data line with the first insulating film interposed therebetween, and overlaps the edge of one of the two outermost common electrodes with the first insulating film and a second insulating film on the data line interposed therebetween.

6. The device according to claim 1, wherein the shield layer is formed in the same direction as the data line, and the two segments of the shield layer are spaced apart from the center of the data line.

7. The device according to claim 1, wherein the shield layer is made of the same material as a gate line and is spaced apart from the gate line, the gate line crossing the data line to define the pixel region.

8. The device according to claim 1, wherein the shield layer is formed between the data line and the two outermost common electrodes.

9. The device according to claim 1, wherein:
a black matrix is formed on the second substrate to correspond to the data line region; and
a color filter layer is formed on the second substrate to correspond to the pixel region.
